(19) United States
(12) Patent Application Publication
(10) Pub. No.: US 2013/0097184 A1
(43) Pub. Date: Apr. 18, 2013

(54) AUTOMATIC UPDATING OF TRUST NETWORKS IN RECOMMENDER SYSTEMS

(71) Applicant: Yahoo! Inc., Sunnyvale, CA (US)

(72) Inventors: Pavel Berkhin, San Jose, CA (US); Farzin Maghoul, Hayward, CA (US)

(73) Assignee: YAHOO! INC., Sunnyvale, CA (US)

(21) Appl. No.: 13/709,764

(22) Filed: Dec. 10, 2012

Related U.S. Application Data
(62) Division of application No. 10/942,335, filed on Sep. 15, 2004.

(51) Int. Cl. G06F 17/30

(52) U.S. Cl. CPC G06F 17/30002
USPC 707/748

(57) ABSTRACT

Trust networks in a recommender system are automatically updated in response to user feedback on recommendations provided by the trust network. In response to a user request, a set of referrals is generated, with some of the referrals being recommended based on judgment data received from members of the trust network. If the user evaluates the recommended referral, a trust parameter for at least one of the trust network members is updated based on the evaluation.

### CROSS-REFERENCES TO RELATED APPLICATIONS

The present disclosure is related to the following commonly-assigned co-pending U.S. patent applications Ser. No. 10/812,719, filed Mar. 29, 2004, entitled “Search Using Graph Colorization and Personalized Bookmark Processing”; and No. 60/553,577, filed Mar. 15, 2004, entitled “Search Systems and Methods with Integration of User Judgments Including Trust Networks.” The respective disclosures of these applications are incorporated herein by reference for all purposes.

### BACKGROUND OF THE INVENTION

The present invention relates in general to search processing in recommender systems, and in particular to automatic updating of a trust network in a recommender system.

The World Wide Web (Web), as its name suggests, is a decentralized global collection of interlinked information—generally in the form of “pages” that may contain text, images, and/or media content—related to virtually every topic imaginable. A user who knows or finds a uniform resource locator (URL) for a page can provide that URL to a Web client program (generally referred to as a browser) and view the page almost instantly. Since Web pages typically include links (also referred to as “hyperlinks”) to other pages, finding URLs is generally not difficult.

What is difficult for most users is finding URLs for pages that are of interest to them. The sheer volume of content available on the Web has turned the task of finding a page relevant to a particular interest into what may be the ultimate needle in a haystack problem. To address this problem, an industry of search providers (e.g., Yahoo!, MSN, Google) has evolved. A search provider typically maintains a database of Web pages in which the URL of each page is associated with information (e.g., keywords, category data, etc.) reflecting its content. The search provider also maintains a search server that hosts a search page (or site) on the Web. The search page (or other search interface) provides a form into which a user can enter a query that usually includes one or more terms indicative of the user's interest. Once a query is entered, the search server accesses the database and generates a list of “hits,” typically URLs for pages whose content matches keywords derived from the user's query. This list is provided to the user. Since queries can often return hundreds, thousands, or in some cases millions of hits, search providers have developed sophisticated algorithms for ranking the hits (i.e., determining an order for displaying hits to the user) such that the pages most relevant to a given query are likely to appear near the top of the list. Typical ranking algorithms take into account not only the keywords and their frequency of occurrence but also other information such as the number of other pages that link to the hit page, page anchor text, and so on.

While automated search technologies can be very helpful, they do have a number of limitations, one of which is that different users will generally evaluate the same item of information differently. Thus, even a site that is generally popular might be unpopular with some group of users. For instance, a page or site that explains how computers work might be very popular among the general public but unpopular among computer experts, who find the information there too basic; the computer experts may prefer a different site that provides more technical detail.

Recently, recommender systems have been developed to assist users in finding information that might be of interest to them. Such systems generally allow users to rate pages or sites they visit and also allow users to define “trust networks” in which a user can identify as “friends” some number of other users whose judgment he or she trusts; in some systems, the user can also assign a weight to each friend's judgment so that trust can be given in degrees. Sites rated favorably by the user's friends, or in some cases, friends of the user's friends (or even more remotely connected members of the trust network), can then be flagged as recommended sites. In some instances, sites rated unfavorably can be flagged as “dis-recommended.” The recommendations will generally be helpful to a given user to the extent that his or her opinions are similar to those of the trust network members.

A user, however, often does not know which of his or her many associates have consistently similar opinions, making it difficult for the user to decide whom to identify as a friend or how much weight to assign to a given friend's judgments. Further, in the interest of protecting privacy, recommender systems may provide only an aggregate judgment to the user. Even in a more open system where ratings of individual trust network members are provided, aggregation of multiple ratings is a complex process, and the user might not be able to determine which friends (or friends of friends) were most responsible for a particular recommendation. Lacking such information, a user who is satisfied or dissatisfied with the recommendations he or she is getting will not know which of many possible modifications to his or her trust network (e.g., adding or deleting friends, changing trust weights, etc.) would improve the likelihood that in the future, recommended content will be of interest to the user.

Therefore, it would be desirable to provide techniques for updating a trust network for a user in a consistently helpful way.

### BRIEF SUMMARY OF THE INVENTION

Embodiments of the present invention provide systems and methods for automatically updating a trust network in response to user feedback on recommendations provided by the trust network. Such systems and methods may be employed in a wide range of contexts, including recommender systems used for finding content on the World Wide Web.

According to one aspect of the present invention, a method for maintaining a trust network for a recommender system is provided. A trust network of direct and indirect relationships among a number of trust network members is defined, with each direct relationship having a trust weight. Judgment data for rated referrals is received from a number of raters, wherein each rater is one of the trust network members. In response to a request from a user, who is one of the plurality of trust network members, a list of referrals is generated; the list of referrals includes at least one of the rated referrals. One of the rated referrals is selected as a recommended referral based on the received judgment data and respective confidence coefficients for at least some of the raters; the confidence coefficients are computed based on the trust weights of the direct relationships in the trust network. The recommended referral is presented to the requesting user. An evaluation of the recommended referral is received from the requesting user. The trust weight of at least one of the relationships between the requesting user and another member of the trust network is updated based on the evaluation. In one embodiment, updating the trust weight includes: identifying as a friend each member of the trust network that has a direct relationship with the requesting user; computing a gain function for each friend; selecting a friend based on the gain function; and computing a new trust weight for the selected friend. In another embodiment, based on the evaluation, a new direct relationship between the requesting user and one of the raters may be proposed.

According to another aspect of the present invention, a computer-based recommender system includes a trust data store, a judgment data store, a request processing module, a transaction module, and an update module. The trust data store is configured to store a trust network of direct and indirect relationships among trust network members, each direct relationship having a trust weight. The judgment data store is configured to store judgment data for rated referrals, the judgment data being received from raters, where each rater is one of the trust network members. The request processing module is configured to receive a request from a requesting user, who is one of the plurality of trust network members, and to generate a list of referrals in response to the request, with the list of referrals including at least one of the rated referrals. The request processing module is further configured to select one of the rated referrals as a recommended referral based on the judgment data in the judgment data store and respective confidence coefficients associated with each of the raters, where the confidence coefficients are computed based on the trust weights of the direct relationships in the trust network. The transaction module is configured to present the recommended referral to the requesting user and to receive from the requesting user an evaluation of the recommended referral. The update module is configured to update the trust weight of at least one of the relationships between the requesting user and another member of the trust network based on the evaluation.

The following detailed description together with the accompanying drawings will provide a better understanding of the nature and advantages of the present invention.

### BRIEF DESCRIPTION OF THE DRAWINGS

FIG. 1 illustrates a general overview of an information retrieval and communication network including a client system according to an embodiment of the present invention.

FIG. 2 illustrates another information retrieval and communication network for communicating media content according to an embodiment of the invention.

FIG. 3 shows a trust network for a user X.

FIG. 4 is a flow diagram of a process for responding to a query in a recommender system according to an embodiment of the present invention.

FIG. 5 is a flow diagram of a process for updating trust weights based on user feedback according to an embodiment of the present invention.

FIG. 6 is a flow diagram of a process 600 for suggesting a new friend according to an embodiment of the present invention.

### DETAILED DESCRIPTION OF THE INVENTION

Embodiments of the present invention provide systems and methods for automatically updating a trust network in response to user feedback on recommendations provided by the trust network. Such systems and methods may be employed in a wide range of contexts, including recommender systems used for finding content on the World Wide Web.

### A. Network Implementation

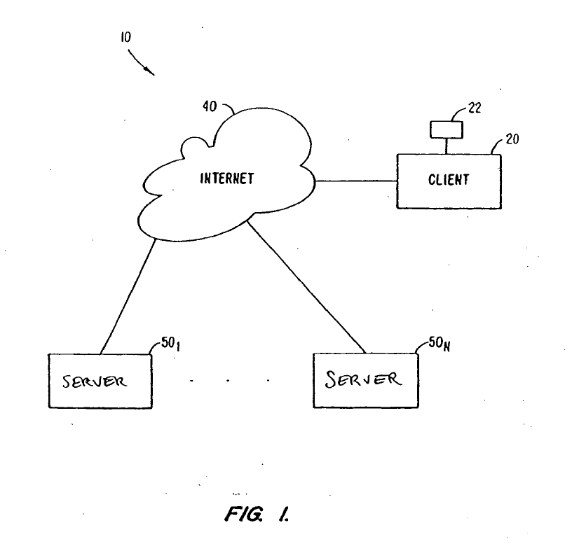

FIG. 1 illustrates a general overview of an information retrieval and communication network 10 including a client system 20 according to an embodiment of the present invention. In computer network 10, client system 20 is coupled through the Internet 40, or other communication network, e.g., over any local area network (LAN) or wide area network (WAN) connection, to any number of server systems 50₁ to 50_{N}. As will be described herein, client system 20 is configured according to the present invention to communicate with any of server systems 50₁ to 50_{N}, e.g., to access, receive, retrieve and display media content and other information such as web pages.

Several elements in the system shown in FIG. 1 include conventional, well-known elements that need not be explained in detail here. For example, client system 20 could include a desktop personal computer, workstation, laptop, personal digital assistant (PDA), cell phone, or any WAP-enabled device or any other computing device capable of interfacing directly or indirectly to the Internet. Client system 20 typically runs a browsing program, such as Microsoft's Internet Explorer™ browser, Netscape Navigator™ browser, Mozilla™ browser, Opera™ browser, or a WAP-enabled browser in the case of a cell phone, PDA or other wireless device, or the like, allowing a user of client system 20 to access, process and view information and pages available to it from server systems 50₁ to 50_{N} over Internet 40. Client system 20 also typically includes one or more user interface devices 22, such as a keyboard, a mouse, touch screen, pen or the like, for interacting with a graphical user interface (GUI) provided by the browser on a display (e.g., monitor screen, LCD display, etc.), in conjunction with pages, forms and other information provided by server systems 50₁ to 50_{N} or other servers. The present invention is suitable for use with the Internet, which refers to a specific global internetwork of networks. However, it should be understood that other networks can be used instead of or in addition to the Internet, such as an intranet, an extranet, a virtual private network (VPN), a non-TCP/IP based network, any LAN or WAN or the like.

According to one embodiment, client system 20 and all of its components are operator configurable using an application including computer code run using a central processing unit such as an Intel Pentium™ processor, AMD Athlon™ processor, or the like or multiple processors. Computer code for operating and configuring client system 20 to communicate, process and display data and media content as described herein is preferably downloaded and stored on a hard disk, but the entire program code, or portions thereof, may also be stored in any other volatile or non-volatile memory medium or device as is well known, such as a ROM or RAM, or provided on any media capable of storing program code, such as a compact disk (CD) medium, a digital versatile disk (DVD) medium, a floppy disk, and the like. Additionally, the entire program code, or portions thereof, may be transmitted and downloaded from a software source, e.g., from one of server systems 50₁ to 50_{N} to client system 20 over the Internet, or transmitted over any other network connection (e.g., extranet, VPN, LAN, or other conventional networks) using any communication medium and protocols (e.g., TCP/IP, HTTP, HTTPS, Ethernet, or other conventional media and protocols).

It should be appreciated that computer code for implementing aspects of the present invention can be C, C++, HTML, XML, Java, JavaScript, etc. code, or any other suitable scripting language (e.g., VBScript), or any other suitable programming language that can be executed on client system 20 or compiled to execute on client system 20. In some embodiments, no code is downloaded to client system 20, and needed code is executed by a server, or code already present at client system 20 is executed.

### Search System

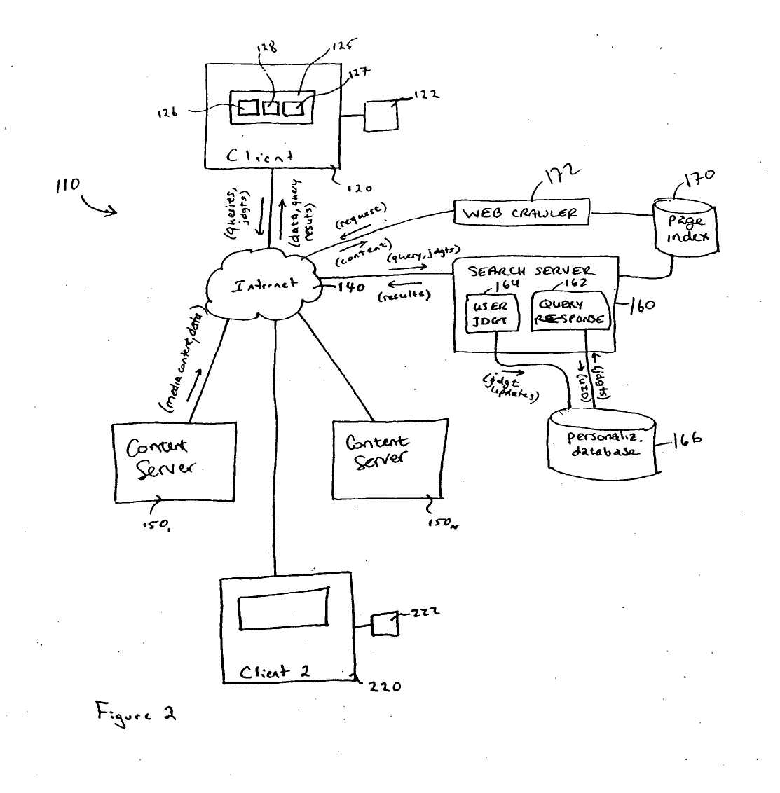

FIG. 2 illustrates another information retrieval and communication network 110 for communicating media content according to an embodiment of the invention. As shown, network 110 includes client system 120, one or more content server systems 150, and a search server system 160. In network 110, client system 120 is communicably coupled through Internet 140 or other communication network to server systems 150 and 160. As discussed above, client system 120 and its components are configured to communicate with server systems 150 and 160 and other server systems over the Internet 140 or other communication networks.

According to one embodiment, a client application (represented as module 125) executing on client system 120 includes instructions for controlling client system 120 and its components to communicate with server systems 150 and 160 and to process and display data content received therefrom. Client application 125 is preferably transmitted and downloaded to client system 120 from a software source such as a remote server system (e.g., server systems 150, server system 160 or other remote server system), although client application module 125 can be provided on any software storage medium such as a floppy disk, CD, DVD, etc., as discussed above. For example, in one aspect, client application module 125 may be provided over the Internet 140 to client system 120 in an HTML wrapper including various controls such as, for example, embedded JavaScript or Active X controls, for manipulating data and rendering data in various objects, frames and windows.

Additionally, client application module 125 includes various software modules for processing data and media content, such as a specialized search module 126 for processing search requests and search result data, a user interface module 127 for rendering data and media content in text and data frames and active windows, e.g., browser windows and dialog boxes, and an application interface module 128 for interfacing and communicating with various applications executing on client 120. Examples of various applications executing on client system 120 for which application interface module 128 is preferably configured to interface with according to aspects of the present invention include various e-mail applications, instant messaging (IM) applications, browser applications, document management applications and others. Further, interface module 127 may include a browser, such as a default browser configured on client system 120 or a different browser.

According to one embodiment, search server system 160 is configured to provide search result data and media content to client system 120, and content server system 150 is configured to provide data and media content such as web pages to client system 120, for example, in response to links selected in search result pages provided by search server system 160. In some variations, search server system 160 returns content as well as, or instead of, links and/or other references to content. Search server system includes a query response module 162 configured to receive a query from a user and generate search result data therefor, as well as a user judgment module 164 configured to detect and respond to user interaction with the search result data.

To enable personalization features such as user judgments, search server 160 advantageously provides a user registration and login feature. When a user registers with search server 160, a unique user ID is created, and information about the user is collected and stored in user profile in a personalization database 166, which may be implemented using conventional techniques. The information stored in personalization database 166 advantageously includes judgment data received from that user as the user evaluates various Web pages or sites, as well as a trust network definition for the user that identifies the user's friends and associates a weight with each friend. At any time when the identity of a registered user is known to search server 160 (e.g., when the user signs in with a user ID and password), search server 160 can access the user's profile and use information from the profile for responding to queries and supporting other user activity such as creation and updating of trust networks.

In some embodiments, search server 160 can process queries for both identified and anonymous users (including unregistered users), but access to personalization features may be limited to identified users. For anonymous users, search server 160 may provide non-personalized recommendations, e.g., based on judgments of global experts as described below.

User judgment module 164 in one embodiment supports collection of judgment data from users. For example, when an identified user enters a query and receives results, the user may be invited to enter ratings for any of the pages or sites that were returned as results. Ratings can be defined using various scales, e.g., “thumbs-up/thumbs-down” for positive or negative, scale of 1 to 5 or 1 to 10, etc. Examples of suitable rating interfaces are described in above-referenced Application No. (−138); it will be appreciated that any interface may be used for collecting judgment data. Regardless of the scale presented to the user, a rating for a page j by a user Y may be represented internally in personalization database 166 by a score s(Y, j) where −1≦s(Y, j)≦1, with positive numbers indicating favorable ratings, negative numbers indicating unfavorable ratings, and zero indicating no rating or a neutral rating.

In one embodiment, user judgment module 164 also supports creation and updating of trust networks by users. For example, user judgment module 164 may communicate with client application module 125 through various Web pages that display information about the user's trust network and accept user input for defining and modifying the trust network. One example of a suitable interface for trust network modification is described in above-referenced Application No. (017887-013800US); other interfaces may also be used.

Trust network data for a user is advantageously also stored in personalization database 166. For example, for user X a list of friends F may be defined, with each friend F being identified by user identifier and having an associated trust weight T_{XF}. In some embodiments, −1≦T_{XF}≦1 for all T_{XF}. In some embodiments, the trust weights may be initialized by the user to desired values; in other embodiments, all trust weights may be initialized automatically (e.g., all equal). In any case, the trust weights are advantageously updated automatically as user X interacts with search server 160 as described below.

Query response module 162 in one embodiment references various page indexes 170 that are populated with, e.g., pages, links to pages, data representing the content of indexed pages, etc. Page indexes may be generated by various collection technologies including an automatic web crawler 172, and/or various spiders, etc., as well as manual or semi-automatic classification algorithms and interfaces for classifying and ranking web pages within a hierarchical structure. These technologies may be implemented on search server system 160 or in a separate system (not shown) that generates a page index 170 and makes it available to search server system 160. Various page index implementations and formats are known in the art and may be used for page index 170.

Query response module 162 is configured to provide data responsive to various search requests (queries) received from a client system, in particular from search module 126. As used herein, the term “query” encompasses any request from a user (e.g., via client 120) to search server 160 that can be satisfied by searching the Web (or other corpus) indexed by page index 170. In one embodiment, a user is presented with a search interface via search module 126. The interface may include a text box into which a user may enter a query (e.g., by typing), check boxes and/or radio buttons for selecting from predefined queries, a directory or other structure enabling the user to limit search to a predefined subset of the full search corpus (e.g., to certain web sites or a categorical subsection within page index 170), etc. Any search interface may be used.

Query response module 162 is advantageously configured with search related algorithms for processing and ranking web pages relative to a given query (e.g., based on a combination of logical relevance, as measured by patterns of occurrence of the search terms in the query; context identifiers associated with query terms and/or particular pages or sites; page sponsorship; connectivity data collected from multiple pages; etc.). For example, query response module 162 may parse a received query to extract one or more keywords, then access page index 170 using the keywords, thereby generating a list of hits. Query response module 162 may also rank the hits using one or more ranking algorithms, which in some embodiments may include conventional ranking algorithms.

In embodiments of the present invention, query response module 162 is also configured to access personalization database 166 to retrieve trust network and judgment information associated with the user who entered the current query and to incorporate such judgment information into the query results. For example, in one embodiment, query response module 162 identifies specific results as promoted (i.e., recommended) or demoted (i.e., not recommended) based on an aggregation of favorable or unfavorable judgments or ratings of particular sites previously entered by friends in the user's trust network and in some embodiments friends of the user's friends and so on.

“Promotion” or “demotion” of results as used herein means that the result data presented to the user includes some indication that a particular page or site in the result list has a favorable or unfavorable recommendation from the user's trust network. Various indications for promotion or demotion may be used. For instance, in a system where results are normally presented using a default font or color scheme, a different font or color scheme may be used to flag particular results as promoted demoted. Icons placed next to each promoted or demoted result or other cues may also be used. In other embodiments, promoted or demoted results may be grouped together on a separate page or a separate area of the results page. In some embodiments, promotion or demotion of results may also involve modifying the order in which results are presented to the user (e.g., the order of a list displayed on a page or series of pages).

When a promoted or demoted result is presented, the user is advantageously invited to rate that result, preferably using the same rating scale as other user judgments. If the user does so, the user's rating is added to personalization database 166 and is also used to update the user's trust network based on whether the user agrees with the trust network's aggregate rating and which members of the trust network most influenced the aggregate rating. Specific examples of such updating are described below; trust weights and/or the user's list of friends may be modified. In some embodiments, the user may also be invited to rate results that were neither promoted nor demoted; thus, a given user can be both a rater of content and a recipient of recommendations based on evaluations by other raters.

It will be appreciated that the search system described herein is illustrative and that variations and modifications are possible. The content server and search server system may be part of a single organization, e.g., a distributed server system such as that provided to users by Yahoo! Inc., or they may be part of disparate organizations. Each server system generally includes at least one server and an associated database system, and may include multiple servers and associated database systems, and although shown as a single block, may be geographically distributed. For example, all servers of a search server system may be located in close proximity to one another (e.g., in a server farm located in a single building or campus), or they may be distributed at locations remote from one another (e.g., one or more servers located in city A and one or more servers located in city B). Thus, as used herein, a “server system” typically includes one or more logically and/or physically connected servers distributed locally or across one or more geographic locations; the terms “server” and “server system” are used interchangeably. In addition, the query response module and user judgment module described herein may be implemented on the same server or on different servers.

The search server system may be configured with one or more page indexes and algorithms for accessing the page index(es) and providing search results to users in response to search queries received from client systems. The search server system might generate the page indexes itself, receive page indexes from another source (e.g., a separate server system), or receive page indexes from another source and perform further processing thereof (e.g., addition or updating of various page information).

### Trust Networks

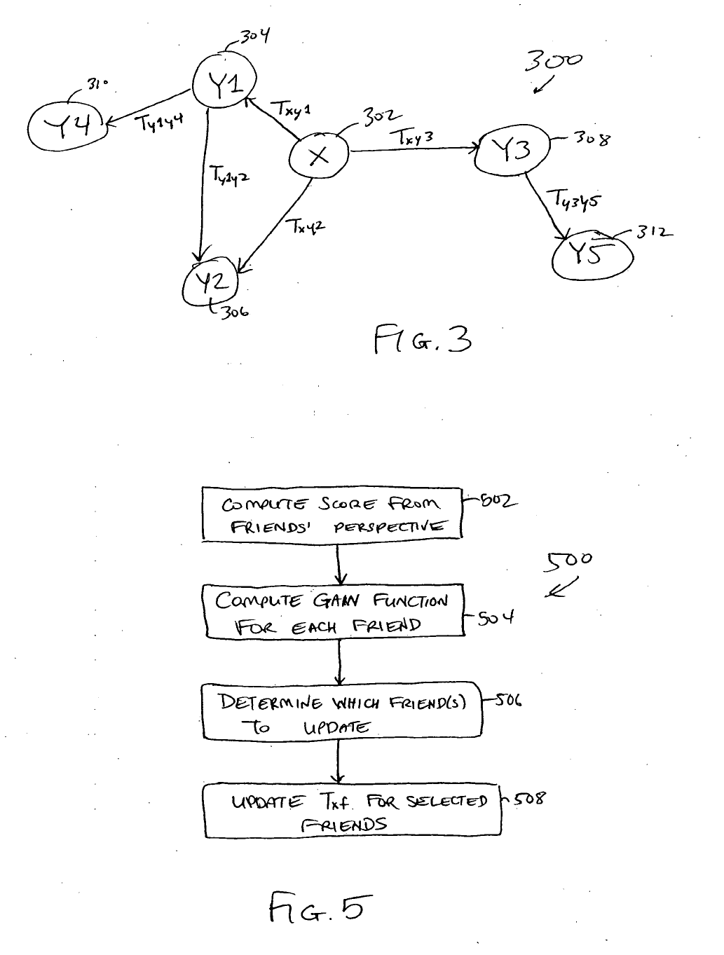

In the following description, the trust network is modeled as a relationship graph, an example of which is shown in FIG. 3. FIG. 3 shows a trust network 300 for a user X. User X is shown at a node 302, and other users Y1-Y5 are shown as nodes 304, 306, 308, 310, 312. The nodes are connected by directed edges (arrows), and each edge has an associated trust weight (T_{XY1}, etc.) reflecting the strength of the relationship. In some examples described herein, trust weights are limited to the range [0, 1]; it will be appreciated that other definitions could be used. For instance, a user creating a trust network or adding a friend might also be allowed to define negative trust weights T_{XY}, e.g., in the range [−1, 0), as well as positive trust weights. A trust weight less than zero indicates that user X is likely to disagree with user Y.

The following terminology is used herein. User X is referred to as the “central node” of the trust network, and relationship edges and weights from node 302 to neighboring nodes 304, 306, 308 represent the degree of trust user X has placed in users Y1, Y2, and Y3. Users whose nodes are directly connected to node 302 (one degree of separation) are referred to as “friends” of user X. The network also has other nodes 310, 312 representing users who are not friends of user X but are members of the trust network. Their trust weights (denoted T_{Y1Y4} and T_{Y3Y5}) are established by users Y1 and Y3, respectively. In this example, the non-friend members Y4 and Y5 are friends of user X's friends (two degrees of separation from user X); it is to be understood that the trust network can be extended to an arbitrary degree of separation from the owner. It should also be noted that user X can be connected to another user by multiple paths; e.g., user X is connected to user Y2 by the direct path X→Y2 and the indirect path X→Y1→Y2.

In responding to a query from user X, query response module 162 (FIG. 2) may use judgment data from any user in X's trust network, including friends or other members up to an arbitrary degree of separation as described below.

It will be appreciated that the trust network described herein is illustrative and that variations and modifications are possible. Any number of users can be included in a trust network, and users may have mutual relationships (e.g., if user X trusts user Y1 who also trusts X) with no correlation required between the trust weights T_{XY1} and T_{Y1X}. In addition, it is to be understood that the graph shown in FIG. 3 is merely a visual convenience for representing trust network relationships, and a representation stored in a database may have any form desired.

### Use of Trust Networks in Query Response

Use of a trust network such as network 300 in responding to a query will now be described. For purposes of this description, it is assumed that the user (referred to herein as user X) who enters the query has already defined a trust network including some number of friends who may also have friends, and that each friend has been assigned a trust weight. It is also assumed that judgment data is available from X's friends. Various techniques for establishing trust networks and collecting judgment data are known in the art, and a detailed description is omitted as not being critical to understanding the present invention.

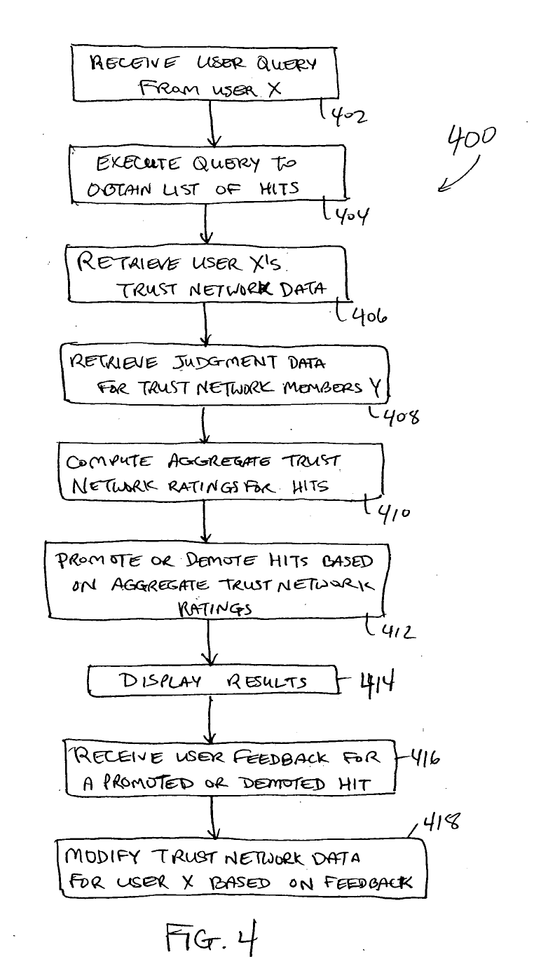

FIG. 4 is a flow diagram of a process 400 for responding to a query in a recommender system according to an embodiment of the present invention. Process 400 may be executed, e.g., by query response module 162 of search server 160 described above, accessing page index 172 and personalization database 166.

At step 402, a query is received from user X (who has signed in or is otherwise identifiable to search server 160). At step 404, the query is executed and a list of search results (e.g., identifiers of pages or sites relevant to the query) is generated using conventional techniques.

At step 406, trust network data for user X in personalization database 166 is retrieved and used to select those members Y whose judgment data is to be used in responding to the query. Conventional techniques for navigating a trust network and selecting members may be used, with the specific implementation depending on how the trust network is represented in personalization database 166. Identification of members Y may be cut off at some point. For instance, only users Y within a pre-selected distance (degree of separation) from user X might be selected. In another embodiment, selection might end when a certain number of users Y has been reached. In still other embodiments, other cutoff rules might be used, or selection may extend through the entire trust network.

At step 408, judgment data for the members Y of X's trust network is retrieved from personalization database 166. At step 410, the judgment data is used to compute an aggregate trust network rating for some or all of the results. This rating can be computed in various ways. For example, an aggregate page score S_{X} (where the subscript X denotes that the score is relative to user X) for a page j can be defined as:

$${S}_{X} ( j ) = {\sum }_{Y} {p}_{X} ( Y ) \cdot s ( Y , j ) , \qquad ( Eq . 1 )$$

where p_{X}(Y) denotes a “confidence coefficient” for user Y based on Y's location in X's trust network and s(Y, j) is user Y's rating for page j.

The confidence coefficient p_{X}(Y) can be defined in various ways based on the trust weights T_{XY} established for the trust network. In one embodiment, p_{X}(Y) is computed using a “portfolio allocation model,” e.g., as described in above-referenced Application No. (−134), in which 100% of the portfolio (in this case, an amount of trust) is allocated among trust network nodes starting from a central node (user X). At each node, a portion α of the portfolio is retained by the node and the remaining portion (1−α) is distributed among that node's friends in proportion to the trust weights. When the allocation is complete, the percentage of the portfolio at each node serves as a confidence coefficient for that node. For instance, for trust network 300 of FIG. 3, one could define:

p_{X}(X)=α, (Eq. 2a)

p_{X}(Y1)=α(1−α) T_{XY1}/(T_{XY1}+T_{XY2}+T_{XY3}), (Eq. 2b)

p_{X}(Y2)=α(1−α) T_{XY2}/(T_{XY1}+T_{XY2}+T_{XY3})+α(1−α)p_{X}(Y1)T_{Y1Y2}/(T_{Y1Y2}+T_{Y1Y4}), (Eq. 2c)

p_{X}(Y3)=α(1−α) T_{XY3}/(T_{XY1}+T_{XY2}+T_{XY3}), (Eq. 2d)

p_{X}(Y4)=α(1−α) p_{X}(Y1) T_{Y1Y4}/(T_{Y1Y2}+T_{Y1Y4}), (Eq. 2e)

p_{X}(Y5)=α(1−α) p_{X}(Y3), (Eq. 2f)

where α represents the fraction of the portfolio that remains in a node and is defined such that 0<α<1.

In another embodiment, confidence coefficients p_{X}(Y) are defined using a “circuit voltage” model, in which each link is treated as having a resistance that is inversely proportional to the trust weight coming into the node and Kirchhoff's laws are applied. In some embodiments, users Y might have trust edges returning to user X; such edges might be used or disregarded depending on implementation. Such models are known in the art. It will be appreciated that the particular definition of the confidence coefficient p_{X}(Y) is not critical to the present invention.

At step 412, results are promoted and demoted based on the aggregate scores of step 410. For example, a result page j may be promoted if S_{X}(j)>S_{high} for a predefined threshold S_{high} and demoted if S_{X}(j)<S_{low} for a predefined threshold S_{low}. Preferably, −1≦S_{low}<0<S_{high}≦1.

At step 414, results are transmitted to the user for display. The displayed results advantageously include an indication of any promoted or demoted results as described above, and user feedback on such results is invited. User feedback on other results might also be invited. At step 416, user feedback for one of the promoted or demoted results is received; in one embodiment, the user feedback takes the form of a rating K where −1≦K≦1. (The providing and receipt of user feedback is referred to herein as a “transaction.”) At step 418, this feedback is used to modify the trust network for user X. Modification can include changing trust weights for existing friends of user X or in some embodiments adding or deleting friends. Examples of such modifications are described in the following section.

It will be appreciated that process 400 is illustrative and that variations and modifications are possible. Steps described as sequential may be executed in parallel, order of steps may be varied, and steps may be modified or combined. Some steps are advantageously performed in real time, while other steps may be performed at periodic intervals. For instance, the query-response interaction and subsequent receipt of user feedback may be performed in real time, while modification of the trust network may be performed at regular intervals based on accumulated user judgment data.

### Updating Trust Networks Based on User Feedback

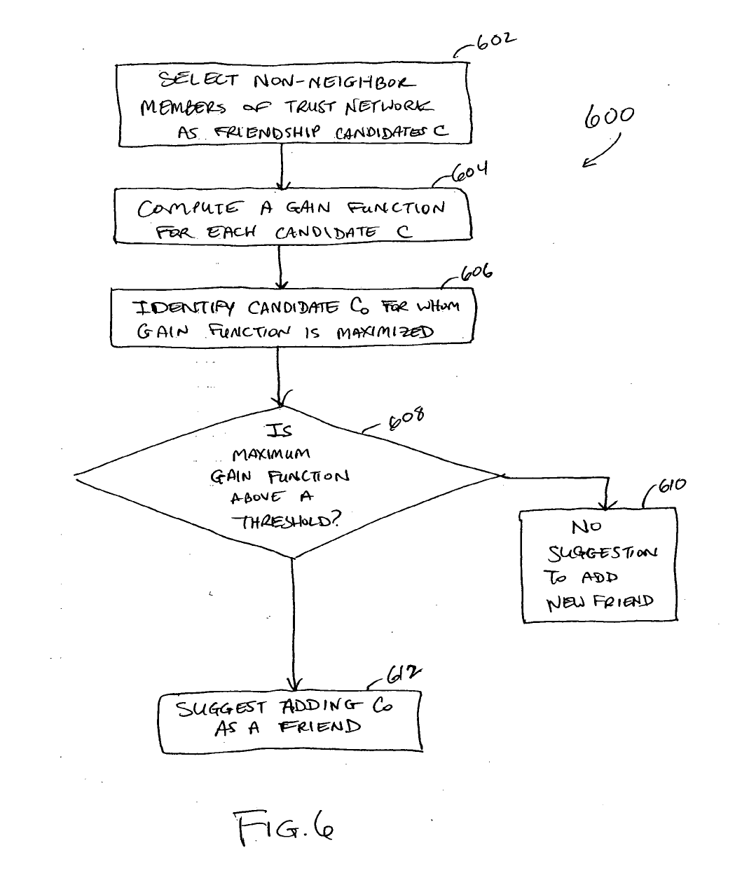

FIG. 5 is a flow diagram of a process 500 for updating trust weights based on user feedback that can be implemented at step 418 of process 400.

At step 502, an aggregate page score S_{F}(j) for the page j for which feedback was received is computed from the perspective of each of user X's friends F. For instance, in network 300 of FIG. 3, friends F would include users Y1, Y2, Y3 but not Y4 or Y5. The computation is generally similar to Eq. 1 above, except that the node for friend F (rather than user X) is used as the origin. A directed edge from the node for friend F to friend X, if present, may be used or disregarded; the decision to use or disregard such an edge is advantageously made consistently with the definition of p_{X}(Y) that was used to compute the aggregate score S_{X}(j).

At step 504, a gain function G(F,j) is computed for a friend F's rating of page j. The gain function G(F, j) for friend F advantageously reflects friend F's contribution to the aggregate score S_{X}(j) that caused the page to be promoted or demoted. In one embodiment, the gain function G(F,j) is equal to or proportional to S_{F}(j). In other embodiments, other parameters may also be used to refine the gain function. For instance, a gain function of the form

G(F,j)=g(S_{F}(j), T_{XF}, s(F,j)) (Eq. 3)

might be defined. Function g( ), which may take various forms, advantageously depends most strongly on S_{F}(j), which directly reflects how much friend F affected the aggregate score S_{X}(j). The dependence on trust weight T_{XF} can be used to reflect a “surprise” element; if T_{XF} is large, it indicates that user X had a high degree of trust in user F already, so it would be expected that X would agree with F's score. The dependence on s(F, j), which is the rating user F gave page j, can be used to reflect whether user F actually gave the page a rating similar to user X's or whether the aggregate score S_{F}(j) came about through F's friends (and their friends). In one embodiment:

g(S_{F}(j), T_{XF}, s(F, j))=(β·S_{F}(j)+(1−β)·s(F, j))·(1−γT_{XF}), (Eq. 4)

where 0.5≦β<1, and 0<γ<1. It is to be understood that other functions may be substituted, including functions that depend on more, fewer, or different parameters.

At step 506, the gain functions G(F,j) for X's friends F are used to determine which, if any, trust weights T_{XF} should be updated. For example, gain function G(F,j) is advantageously defined such that G tends to be larger when S_{F}(j) is larger. If page j was promoted based on the aggregate score S_{X}(j) and user X also gave page j a favorable rating, then the friend F with the largest G(F,j) likely contributed most to the promotion, while the friend F with the smallest G(F, j) probably contributed the least and may even have been counterproductive (e.g., if S_{F}(j) was negative). Thus, in one embodiment, the friends with maximum G(F, j) and minimum G(F,j) are selected for updating.

In some embodiments, there might be cases where no friends are selected for updating at step 506. For instance, an upper (or lower) threshold may be placed on G(F,j), and if no friend has G above (or below) this threshold, then no trust weights are modified.

At step 508, trust weights T_{XF} are updated for each friend selected at step 506. A variety of algorithms can be used, with the algorithm advantageously having the property that T_{XF} increases if user X agreed with friend F's rating and decreases if X disagreed.

In one such algorithm, a confidence factor ω_{XF} is defined, reflecting the history of the XF edge; ω_{XF} can be initialized to zero and updated according to:

ω_{XF}′=Σ·ω_{XF}+1, (Eq. 5)

where ρ is a preselected discounting parameter (0<ρ<1) that is applied to all edges. The trust weight T_{XF} is then updated according to a history-dependent update function:

T_{XF}′=[Ω_{XF}·ρ·T_{XF}+K₀]/ω_{XF}′, (Eq. 6)

where K₀ is derived from the feedback rating K received from user X at step 416 of process 400 (FIG. 4). In one embodiment, K₀ is set equal to the absolute value of user X's rating K (so that T_{XF} is increased) if X and F agreed on the score and to −|K| (so that T_{XF} is decreased) if they disagreed. Agreement or disagreement can be determined based on whether user X's rating K and friend F's rating s(F,j) have the same sign (agreement) or different signs (disagreement). In one embodiment, K₀=K·s(F,j). Other functions may also be used to update the trust weights.

It should be noted that trust weights T_{XF} for some friends might become negative through updating. In some embodiments, negative trust weights are allowed; if a user consistently disagrees with a particular friend, that friend's opinions can still be used as an indication that the user's opinion is likely to be the opposite. In other embodiments, trust weights that fall below zero are updated to zero, effectively removing that user from the trust network. The user may optionally be notified of friends whose trust weight has fallen to zero.

In another embodiment, updating a trust network in response to user feedback may also include creating new relationships or suggesting to the user that a new relationship be created. The decision to create a new relationship is advantageously based on detecting members of the trust network other than X's friends F who contribute significantly to a recommendation that the user agreed with.

FIG. 6 is a flow diagram of a process 600 for suggesting a new friend based on user feedback in a case where the user agreed with a favorable recommendation. Process 600 can be implemented at step 418 of process 400.

At step 602, one or more trust network members Y who are not friends of user X are selected as friendship candidates C. The pool of candidates C is advantageously limited to those trust network members who could have contributed to the recommendation; for instance, if at step 406 of process 400 (FIG. 4) identification of trust network members was limited by a maximum degree of separation or other criterion, then the selection of members C at step 602 of process 600 can be limited by the same criterion.

At step 604 a gain function is computed for each candidate C. The gain function advantageously reflects candidate C's contribution to the aggregate trust network score. For example, where the aggregate score is computed using Eq. 1 above, a gain function can be defined as:

G′(C, j)=h(p_{X}(C), s(C, j)). (Eq. 7)

The function h( ) may take various forms. In one embodiment h(p, s)=p^{μ}·s for a parameter μ where μ≧1. Since the confidence coefficient p tends to decrease with the number of degrees of separation between users X and Y, such a form can capture the relatively small influence of remote members of user X's trust network. Other forms may also be used. For example, in some embodiments, G′(C, j) may also depend on a “global” authority weight assigned to user C. Global authority weights are described further below.

At step 606, a candidate C₀ with the maximum gain function value is identified. If multiple candidates C share the maximum gain function value, multiple candidates C₀ may be identified. At step 608, the maximum gain function value is compared to a threshold; if the maximum is below the threshold, a suggestion to add a user is not made (step 610).

If the maximum gain function value is above the threshold, then at step 612, a suggestion is made to user X to add C₀ as a friend in X's trust network. The suggestion can be conveyed to the user in a variety of ways. In one embodiment, search server 160 (FIG. 2) supports a user interface page that enables users to view and modify their trust networks. A suggestion to add user C₀ as a friend may be presented to user X in a designated area of the interface page when X logs in and views the page. In another embodiment, an e-mail message can be sent to user X. The message advantageously includes an identifier of the suggested friend C₀ and an instruction for how to accept the suggestion (e.g., a link that the user can follow or an automated reply address). In other embodiments, other notification mechanisms might be used.

It will be appreciated that the updating processes described herein is illustrative and that variations and modifications are possible. Steps described as sequential may be executed in parallel, order of steps may be varied, and steps may be modified or combined. Gain functions, updating functions for the trust weights, and other process parameters, are not limited to any particular formulation or value.

In addition, updating processes have been described herein with reference to a case where the user's trust network gave a favorable recommendation and the user agreed. Persons of ordinary skill in the art will recognize that similar processes may also be used to perform updates in other cases, such as where the trust network gave an unfavorable recommendation and the user agreed, or where the user disagreed with either a favorable or unfavorable recommendation.

Further, updating of trust weights or suggestion of new friends after every transaction is not required. In some embodiments, gain functions for each relevant trust network members can be aggregated over a number of transactions by the network's owner, with updates being performed based on the aggregate gain function.

In still further embodiments, a process for suggesting removal of an existing friend may be provided. Similarly to processes described above, the suggestion to remove could be based on a gain function reflecting that the existing friend's contribution to an aggregate score runs contrary to the user's opinion, or on detecting that a friend's trust weight has fallen below some threshold.

### Global Authority

As trust networks are updated in response to user feedback, the trust weights will tend to evolve to provide a reliable reflection of who agrees with whom. In some embodiments, this evolution may be exploited to identify users who are relatively highly trusted by many other users as “global” authorities or experts.

For example, as described above, each confidence coefficient p_{X}(Y) indicates the degree of trust a particular user X has in user Y. Aggregating p_{X}(Y) over a large number of users X, such as all users X or all users X at less than some maximum degree of separation from user Y, provides a measure of the general level of trust other users have for user Y. Users Y with suitably high aggregate confidence coefficients P(Y) may be identified as “global experts” or “global authorities.” Identification of experts may be based on a threshold, a percentile model, or the like. Other measures of the relative level of trust in various users Y across the community of users participating in the recommender system may also be used in place of or in addition to confidence coefficients p_{X}(Y).

Once global experts have been identified, their judgment information may be used to further augment the recommender system. For example, there may be cases where the recommender system is used by an anonymous user (or an identified user who has not defined a trust network). In such cases, a recommendation can be based, wholly or in part, on an aggregate judgment of the global experts, e.g., with each expert's judgment weighted by the corresponding aggregate confidence coefficient P(Y). In addition, when a new user is defining a trust network, the system may be configured to suggest global experts as possible new friends.

It should be noted that where trust weights are updated automatically based on user behavior, it will be relatively difficult for a user to rig the trust weights to make himself or herself an “expert.”

While the invention has been described with respect to specific embodiments, one skilled in the art will recognize that numerous modifications are possible. For instance, while the description herein refers to embodiments in which the recommendation system is related to the World Wide Web, the invention may be employed in any type of referral or recommendation system, including recommendation systems for service providers, restaurants, sellers and the like.

In some embodiments, users may be able to define different trust networks, e.g., corresponding to different interests or different contexts. The updating procedures described herein may be applied to each trust network.

In addition, the embodiments described herein have been described with reference to general-purpose computer systems that are configurable through software programs to execute various processes. It will be appreciated that processes described herein can be implemented in a variety of systems including any combination of hardware and/or software components.

Thus, although the invention has been described with respect to specific embodiments, it will be appreciated that the invention is intended to cover all modifications and equivalents within the scope of the following claims.

1.-29. (canceled)

30. A computerized method for maintaining a trust network for a recommender system, the method comprising:
electronically defining, via a processing device, a trust network of direct and indirect relationships among a plurality of trust network members, each direct relationship having a trust weight;
receiving judgment data of content items for the plurality of trust network members having a trust weight value associated therewith that is above a threshold value;
in response to a search request from a user, electronically generating a list of given members from the plurality of trust network members via the processing device, wherein the requesting user is one of the plurality of trust network members and wherein the list of given members includes at least one of the plurality of trust network members having the trust weight value above the threshold value;
electronically selecting one or more of the given members based on the received judgment data and respective confidence coefficients for at least some of the plurality of trust network members, wherein the confidence coefficients are computed based on the trust weights of the direct relationships in the trust network, wherein selection of the one or more given members is based on the network members that have a direct relationship with the user;
presenting one or more rated content items of the selected given members according to the received judgment data and respective confidence coefficients to the requesting user of the search request;
receiving from the requesting user an evaluation of the rating of the one or more rated content items; and
updating the trust weight of at least one of the relationships between the requesting user and another member of the trust network based on the evaluation of the rating of the one or more rated content items.

31. The method of claim 30, wherein presenting the one or more rated content items includes:
updating the trust network to indicate that the one or more selected given members are suggested as new friends; and
presenting the updated trust network to the user.

32. The method of claim 30, wherein selecting the one or more of the given members includes computing a score for each of the plurality of trust network members.

33. The method of claim 32, wherein the judgment data includes a numerical rating and wherein computing the score includes:
weighting the numerical rating given by each of the plurality of trust network members by the respective confidence coefficient for that trust network member, and
adding the weighted numerical ratings.

34. The method of claim 30, wherein the relationship between the requesting user and at least one of the trust network members is an indirect relationship.

35. The method of claim 34, wherein the confidence coefficient associated with each indirectly related trust network member is determined based on a sequence of direct relationships linking the requesting user to the indirectly related trust network member.

36. The method of claim 35, wherein the confidence coefficients are determined using a portfolio allocation model.

37. The method of claim 30, wherein updating the trust weight includes:
identifying as a friend each member of the trust network that has a direct relationship with the requesting user;
computing a gain function for each friend;
selecting a friend based on the gain function; and
computing a new trust weight for the selected friend.

38. The method of claim 37, wherein the gain function is based at least in part on judgment data provided by the friend.

39. The method of claim 37, wherein the gain function is based at least in part on judgment data provided by a trust network member directly or indirectly related to the friend.

40. The method of claim 37, wherein the gain function is based in part on the trust weight of the relationship between the requesting user and the friend.

41. The method of claim 37, wherein the new trust weight is computed according to a history-dependent update function.

42. The method of claim 30, further comprising proposing, based on the evaluation, a new direct relationship between the requesting user and one of the trust network members.

43. The method of claim 42, wherein proposing a new direct relationship includes:
identifying as a candidate at least one trust network member that is not directly related to the requesting user;
computing a gain function for each candidate;
determining, based on the gain functions, whether to propose a direct relationship between the requesting user and the candidate; and
transmitting information about the proposed direct relationship to the requesting user.

44. The method of claim 42, further comprising:
adding the proposed direct relationship to the trust network in response to an acceptance of the proposed direct relation by the requesting user.

45. The method of claim 30, further comprising:
computing an updated global authority score for at least one member of the trust network, the updated global authority score indicating a level of trust for the at least one member of the trust network with a community of trust network members, wherein the updated global authority score is based at least in part on the updated trust weight.

46. A computer-based recommender system comprising:
a trust data store configured to store a trust network of direct and indirect relationships among a plurality of trust network members, each direct relationship having a trust weight;
a judgment data store configured to store judgment data of content items, the judgment data being received from the plurality of trust network members having a trust weight value associated therewith that is above a threshold value;
a request processing module configured to receive a search request from a requesting user, the requesting user being one of the plurality of trust network members, and to generate a list of given members from the plurality of trust network members in response to the request, the list of given members including at least one of the plurality of trust network members having the trust weight value above the threshold;
the request processing module being further configured to select one or more of the given members based on the judgment data in the judgment data store and respective confidence coefficients associated with each of the trust network members, wherein the confidence coefficients are computed based on the trust weights of the direct relationships in the trust network, wherein selection of the one or more given members is based on the network members having a direct relationship with the user;
a transaction module configured to present one or more rated content items of the selected given members according to the received judgment data and respective confidence coefficients to the requesting user of the search request and to receive from the requesting user an evaluation of the rating of the one or more rated content items; and
an update module configured to update the trust weight of at least one of the relationships between the requesting user and another member of the trust network based on the evaluation of the one or more rated content items.

47. The system of claim 46, wherein the judgment data includes numerical ratings and wherein the request processing module is further configured to use the numerical ratings to compute a score for each of the plurality of trust network members and to select the one or more rated content items based on the respective scores of the trust network members.

48. The system of claim 46, wherein the update module is further configured to identify as a friend each member of the trust network that has a direct relationship with the requesting user, to compute a gain function for each friend, to select a friend based on the gain function, and to compute a new trust weight for the selected friend.

49. The system of claim 48, wherein the update module is further configured to:
identify as a candidate at least one trust network member that is not directly related to the requesting user;
compute a gain function for each candidate;
determine, based on the gain functions, whether to propose a direct relationship between the requesting user and the candidate;
transmit information about the proposed direct relationship to the requesting user; and
add the proposed direct relationship to the trust network in response to an acceptance of the proposed direct relation by the requesting user.
